(19) United States
(12) Patent Application Publication
(10) Pub. No.: US 2010/0225574 A1
(43) Pub. Date: Sep. 9, 2010

(54) IMAGE DISPLAY DEVICE AND IMAGE DISPLAY METHOD

(76) Inventors: Kohji Fujiwara, Osaka (JP); Katsuya Otoi, Osaka (JP); Katsuteru Hashimoto, Osaka (JP)

Correspondence Address: BIRCH STEWART KOLASCH & BIRCH, PO BOX 747, FALLS CHURCH, VA, 22040-0747, US

(21) Appl. No.: 12/681,756

(22) PCT Filed: Oct. 9, 2008
(86) PCT No.: PCT/JP2008/068366

§ 371 Date: Apr. 5, 2010

(30) Foreign Application Priority Data
Jan. 31, 2008 (JP) 2008-020094

(51) Int. Cl. G09G 3/36

(52) U.S. Cl. 345/102

(57) ABSTRACT

An objective of the present invention is to provide an image display device that performs area active drive and that can suppress the occurrence of flicker upon displaying a moving image. An APL calculating unit (16) obtains, based on an input image (31), an average luminance level of the image for one frame. A luminance range determining unit (151) determines an upper limit value and a lower limit value of luminances of LEDs, based on the average luminance level. An area active drive processing unit (15) obtains, based on the input image (31), liquid crystal data (32) used to drive a liquid crystal panel (11) and LED data (33) used to drive a backlight (13). When the LED data (33) is obtained, the input image (31) is divided into a plurality of areas and a luminance of LEDs corresponding to each area is obtained within a range between the upper limit value and the lower limit value which are determined by the luminance range determining unit (151).

### TECHNICAL FIELD

The present invention relates to an image display device and more particularly to an image display device having the function of controlling the luminance of a backlight (backlight dimming function).

### BACKGROUND ART

In image display devices having a backlight such as liquid crystal display devices, by controlling the luminance of the backlight based on an input image, the power consumption of the backlight can be suppressed and the image quality of a displayed image can be improved. Particularly, by dividing a screen into a plurality of areas and controlling, based on an input image in an area, the luminance of backlight light sources corresponding to the area, a further reduction in power consumption and a further improvement in image quality are enabled. A method to drive a display panel while the luminance of backlight light sources is thus controlled based on an input image in an area is hereinafter referred to as “area active drive”.

A liquid crystal display device that performs area active drive uses, for example, LEDs (Light Emitting Diodes) of three RGB colors or white LEDs, as backlight light sources. The luminance of LEDs corresponding to each area is obtained based on a maximum value or an average value of the luminances of pixels in the area, etc., and the obtained luminances are provided, as LED data, to a drive circuit for a backlight. In addition, based on the LED data and an input image, display data (data for controlling the light transmittances of liquid crystals) is generated and the display data is provided to a drive circuit for a liquid crystal panel. Note that the luminance of each pixel on a screen is the product of a luminance of light from a backlight and a light transmittance based on display data. Here, light emitted from a single LED hits a plurality of areas including a corresponding area and areas around the corresponding area. Thus, the luminance of each pixel is the product of the sum of the luminances of lights emitted from a plurality of LEDs and a light transmittance based on display data.

According to a liquid crystal display device such as that described above, by obtaining suitable display data and LED data based on an input image, controlling the light transmittances of liquid crystals based on the display data, and controlling the luminances of LEDs corresponding to respective areas based on the LED data, the input image can be displayed on a liquid crystal panel. When the luminance of pixels in an area is low, by reducing the luminance of LEDs corresponding to the area, the power consumption of a backlight can be reduced.

Note that in relation to such an invention the following prior art documents are known. Japanese Patent Application Laid-Open No. 2002-108305 discloses an invention of a liquid crystal display device having backlight dimming control and a limiter which take into account an average luminance of an input signal and a gamma adjustment value. Japanese Patent Application Laid-Open No. 2002-333858 discloses an invention of an image display device that adjusts a dynamic range of an image signal displayed on a display unit, according to an average signal level of inputted pixel signals. Japanese Patent Application Laid-Open No. 2007-140436 discloses an invention of a liquid crystal display device that changes, according to an image tone mode, a luminance control characteristic which defines the light-emission luminance of a light source relative to the amount of characteristic of an input video signal.

[Patent Document 1] Japanese Patent Application Laid-Open No. 2002-108305

[Patent Document 2] Japanese Patent Application Laid-Open No. 2002-333858

[Patent Document 3] Japanese Patent Application Laid-Open No. 2007-140436

### DISCLOSURE OF THE INVENTION

### Problems to be Solved by the Invention

Meanwhile, the number of LEDs included in a backlight is smaller than the number of pixels of a display panel. Hence, when a moving image is displayed by area active drive, a maximum value (or an average value) of the luminances of pixels in an area changes every frame and thus the luminances of LEDs change every frame and accordingly flicker (flickering) may occur on a screen. The flicker is more noticeable when the screen is dark than when the screen is bright. The flicker will be described below.

For example, the case of displaying, as shown in FIG. 26, a moving image in which a white (luminance of 100%) bar 62 having a predetermined width moves to the left on a black (luminance of 0%) background will be considered. In this case, a maximum value of the luminances of pixels in an area 61 rises from 0% to 100% immediately after a part of the bar 62 enters the area 61. Thus, when the luminance of LEDs is determined based on a maximum value of the luminances of pixels in each area, the luminance of LEDs corresponding to the area 61 abruptly changes from a minimum luminance to a maximum luminance. As a result, large flicker occurs on a screen. As such, in an image display device that performs area active drive, flicker is likely to be visually recognized upon displaying a moving image.

An object of the present invention is therefore to provide an image display device that performs area active drive and that can suppress the occurrence of flicker upon displaying a moving image.

### Means for Solving the Problems

A first aspect of the present invention is directed to an image display device having a function of controlling a luminance of a backlight, the image display device comprising:
a display panel including a plurality of display elements;
a backlight including a plurality of light sources;
a signal processing unit that obtains display data and backlight control data, based on an input image;
a luminance range determining unit that determines an upper limit value and a lower limit value of luminances of the light sources;
a panel drive circuit that outputs a signal for controlling light transmittances of the display elements to the display panel, based on the display data; and
a backlight drive circuit that outputs a signal for controlling the luminances of the light sources to the backlight, based on the backlight control data, wherein
when the signal processing unit obtains the backlight control data, the signal processing unit divides the input image into a plurality of areas and obtains a luminance of light sources corresponding to each area, within a range between the upper limit value and the lower limit value which are determined by the luminance range determining unit.

According to a second aspect of the present invention, in the first aspect of the present invention,
the image display device further comprises an average luminance calculating unit that calculates an average luminance of the input image for one screen, wherein
the luminance range determining unit determines an upper limit value and a lower limit value of luminances of the light sources, based on the calculated average luminance which is the average luminance calculated by the average luminance calculating unit.

According to a third aspect of the present invention, in the second aspect of the present invention,
the luminance range determining unit determines a lower limit value of luminances of the light sources such that as the calculated average luminance increases the lower limit value increases.

According to a fourth aspect of the present invention, in the second aspect of the present invention,
the luminance range determining unit determines an upper limit value of luminances of the light sources such that as the calculated average luminance increases the upper limit value decreases.

According to a fifth aspect of the present invention, in the first aspect of the present invention,
the image display device further comprises an illuminance detecting unit that detects an illuminance received by the display panel, wherein
the luminance range determining unit determines an upper limit value and a lower limit value of luminances of the light sources, based on the detected illuminance which is the illuminance detected by the illuminance detecting unit.

According to a sixth aspect of the present invention, in the fifth aspect of the present invention,
the luminance range determining unit determines a lower limit value of luminances of the light sources such that as the detected illuminance increases the lower limit value increases.

According to a seventh aspect of the present invention, in the fifth aspect of the present invention,
the luminance range determining unit determines an upper limit value of luminances of the light sources such that as the detected illuminance decreases the upper limit value decreases.

According to an eighth aspect of the present invention, in the fifth aspect of the present invention,
when the detected illuminance is lower than or equal to a predetermined illuminance, the luminance range determining unit determines an upper limit value of luminances of the light sources such that as the detected illuminance decreases the upper limit value decreases, and determines a lower limit value of luminances of the light sources such that as the detected illuminance increases the lower limit value increases.

According to a ninth aspect of the present invention, in the first aspect of the present invention,
the image display device further comprises a temperature detecting unit that detects a temperature of the backlight, wherein
the luminance range determining unit determines an upper limit value and a lower limit value of luminances of the light sources, based on the detected temperature which is the temperature detected by the temperature detecting unit.

According to a tenth aspect of the present invention, in the ninth aspect of the present invention,
when the detected temperature is higher than or equal to a predetermined temperature, the luminance range determining unit determines an upper limit value of luminances of the light sources such that as the detected temperature increases the upper limit value decreases.

According to an eleventh aspect of the present invention, in the first aspect of the present invention,
the image display device further comprises a moving image ratio calculating unit that determines for each area whether an image in the area is a moving image or a still image and calculates, as a screen moving image ratio, a ratio of a number of areas that are determined to have moving images to a number of the plurality of areas, based on the input image, wherein
the luminance range determining unit determines an upper limit value and a lower limit value of luminances of the light sources, based on the calculated screen moving image ratio which is the screen moving image ratio calculated by the moving image ratio calculating unit.

According to a twelfth aspect of the present invention, in the eleventh aspect of the present invention,
when the calculated screen moving image ratio is lower than or equal to a predetermined value, the luminance range determining unit determines a lower limit value of luminances of the light sources such that as the calculated screen moving image ratio increases the lower limit value increases; and when the calculated screen moving image ratio is higher than or equal to the predetermined value, the luminance range determining unit determines an upper limit value of luminances of the light sources such that as the calculated screen moving image ratio increases the upper limit value decreases.

According to a thirteenth aspect of the present invention, in the first aspect of the present invention,
the image display device further comprises a histogram generating unit that generates a histogram representing a luminance distribution of the input image, wherein
the luminance range determining unit determines an upper limit value and a lower limit value of luminances of the light sources, based on the histogram generated by the histogram generating unit.

A fourteenth aspect of the present invention is directed to an image display method for an image display device that has a display panel including a plurality of display elements; and a backlight including a plurality of light sources, the image display method comprising:
a signal processing step of obtaining display data and backlight control data, based on an input image;
a luminance range determining step of determining an upper limit value and a lower limit value of luminances of the light sources;
a panel driving step of outputting a signal for controlling light transmittances of the display elements to the display panel, based on the display data; and
a backlight driving step of outputting a signal for controlling the luminances of the light sources to the backlight, based on the backlight control data, wherein
in the signal processing step, when the backlight control data is obtained, the input image is divided into a plurality of areas and a luminance of light sources corresponding to each area is obtained within a range between the upper limit value and the lower limit value which are determined in the luminance range determining step.

In addition, variants that are grasped by referring to the embodiments and the drawings in the fourteenth aspect of the present invention are considered to serve as means for solving the problems.

### Effects of the Invention

According to the first aspect of the present invention, in the image display device that controls the luminances of light sources on an area-by-area basis, when the luminance of light sources corresponding to each area is obtained, the upper limit value and lower limit value of luminances are determined in advance. Hence, by determining the upper limit value of luminances to be lower than a maximum luminance and determining the lower limit value of luminances to be higher than a minimum luminance, the difference in luminance between the areas decreases over conventional cases. Thus, even if the luminance of the light sources in each area changes every frame by displaying a moving image, the occurrence of flicker is suppressed.

According to the second aspect of the present invention, the upper limit value and lower limit value of the luminances of the light sources are determined based on an average luminance of an image. Hence, since the upper limit value and lower limit value of the luminances of the light sources can be determined taking into account the overall brightness of the image, while a reduction in luminance is suppressed, the occurrence of flicker upon displaying a moving image can be suppressed.

According to the third aspect of the present invention, as the average luminance of an image increases, the lower limit value of the luminances of the light sources increases. Hence, when display of an overall bright image is performed, the difference in luminance between the areas decreases and thus the occurrence of flicker is effectively suppressed. In addition, when display of an overall dark image is performed, since the difference in luminance between the areas increases, high contrast is obtained.

According to the fourth aspect of the present invention, as the average luminance of an image increases, the upper limit value of the luminances of the light sources decreases. Hence, when display of an overall bright image is performed, the difference in luminance between the areas decreases and accordingly the occurrence of flicker is effectively suppressed, and by the reduction in the upper limit value of the luminances of the light sources, power consumption and the amount of heat are reduced. In addition, when display of an overall dark image is performed, since the difference in luminance between the areas increases, high contrast is obtained.

According to the fifth aspect of the present invention, the upper limit value and lower limit value of the luminances of the light sources are determined based on an illuminance received by the display panel. Hence, since the upper limit value and lower limit value of the luminances of the light sources can be determined taking into account the brightness of a usage environment, while the glare perceived by persons is considered, the occurrence of flicker upon displaying a moving image can be suppressed.

According to the sixth aspect of the present invention, as the illuminance increases, the lower limit value of the luminances of the light sources increases. Hence, when the image display device is used in a bright environment, the difference in luminance between the areas decreases and thus the occurrence of flicker is effectively suppressed. In addition, when the image display device is used in a dark environment, since the difference in luminance between the areas increases, high contrast is obtained.

According to the seventh aspect of the present invention, as the illuminance decreases, the upper limit value of the luminances of the light sources decreases. Hence, when the image display device is used in a dark environment, the difference in luminance between the areas decreases and accordingly the occurrence of flicker is effectively suppressed, and by the reduction in the upper limit value of the luminances of the light sources, glare is lessened.

According to the eighth aspect of the present invention, by determining the upper limit value of the luminances of the light sources to be lower than a maximum luminance and determining the lower limit value of the luminances of the light sources to be higher than a minimum luminance, the difference in luminance between the areas decreases and thus the occurrence of flicker upon displaying a moving image is suppressed.

According to the ninth aspect of the present invention, the upper limit value and lower limit value of the luminances of the light sources are determined based on the temperature of the backlight. Thus, taking into account thermal runaway caused by an increase in the temperature of the backlight, the upper limit value and lower limit value of the luminances of the light sources can be determined.

According to the tenth aspect of the present invention, when the temperature of the backlight is higher than or equal to a predetermined temperature, as the temperature of the backlight increases, the upper limit value of the luminances of the light sources decreases. Thus, thermal runaway caused by an increase in the temperature of the backlight is suppressed and power consumption is reduced.

According to the eleventh aspect of the present invention, the upper limit value and lower limit value of the luminances of the light sources are determined based on the proportion of moving images included in an image. Thus, while a reduction in luminance upon displaying a still image is suppressed, the occurrence of flicker upon displaying a moving image can be suppressed.

According to the twelfth aspect of the present invention, as the proportion of moving images included in an image increases, the difference in luminance between the areas decreases. Thus, flicker upon displaying a moving image is effectively suppressed.

According to the thirteenth aspect of the present invention, the upper limit value and lower limit value of the luminances of the light sources are determined based on the luminance distribution of an image. Accordingly, since the upper limit value and lower limit value of the luminances of the light sources can be determined according to the overall trend of an image, when an image where flicker is likely to be visually recognized is displayed, the difference in luminance between the areas decreases and accordingly the occurrence of flicker can be suppressed.

### BRIEF DESCRIPTION OF THE DRAWINGS

FIG. 1 is a block diagram showing a configuration of a liquid crystal display device according to a first embodiment of the present invention.

FIG. 2 is a diagram showing a detail of a backlight shown in FIG. 1.

FIG. 3 is a flowchart showing a process of an area active drive processing unit in the first embodiment.

FIG. 4 is a diagram showing a correspondence relationship between APL and the upper limit value/lower limit value of LED luminances in the first embodiment.

FIG. 5 is a diagram showing the process of obtaining liquid crystal data and LED data in the first embodiment.

FIG. 6 is a diagram showing a first variant of the correspondence relationship between APL and the upper limit value/lower limit value of LED luminances in the first embodiment.

FIG. 7 is a diagram showing a second variant of the correspondence relationship between APL and the upper limit value/lower limit value of LED luminances in the first embodiment.

FIG. 8 is a block diagram showing a configuration of a liquid crystal display device according to a second embodiment of the present invention.

FIG. 9 is a flowchart showing a process of an area active drive processing unit in the second embodiment.

FIG. 10 is a diagram showing a correspondence relationship between ambient illuminance and the upper limit value/lower limit value of LED luminances in the second embodiment.

FIG. 11 is a diagram showing a first variant of the correspondence relationship between ambient illuminance and the upper limit value/lower limit value of LED luminances in the second embodiment.

FIG. 12 is a diagram showing a second variant of the correspondence relationship between ambient illuminance and the upper limit value/lower limit value of LED luminances in the second embodiment.

FIG. 13 is a block diagram showing a configuration of a liquid crystal display device according to a third embodiment of the present invention.

FIG. 14 is a flowchart showing a process of an area active drive processing unit in the third embodiment.

FIG. 15 is a diagram showing an example of a correspondence relationship between BLU temperature and the upper limit value/lower limit value of LED luminances in the third embodiment.

FIG. 16 is a block diagram showing a configuration of a liquid crystal display device according to a fourth embodiment of the present invention.

FIG. 17 is a flowchart showing a process of an area active drive processing unit in the fourth embodiment.

FIG. 18 is a flowchart showing a process of an MPL calculating unit in the fourth embodiment.

FIG. 19 is a diagram showing an example of a correspondence relationship between MPL and the upper limit value/lower limit value of LED luminances in the fourth embodiment.

FIG. 20 is a block diagram showing a configuration of a liquid crystal display device according to a fifth embodiment of the present invention.

FIG. 21 is a flowchart showing a process of an area active drive processing unit in the fifth embodiment.

FIG. 22 is a diagram for describing an exemplary histogram analysis (first example) in the fifth embodiment.

FIG. 23 is a diagram for describing an exemplary histogram analysis (second example) in the fifth embodiment.

FIG. 24 is a diagram for describing an exemplary histogram analysis (third example) in the fifth embodiment.

FIG. 25 is a diagram for describing an exemplary histogram analysis (fourth example) in the fifth embodiment.

FIG. 26 is a diagram showing an example of a screen where flicker occurs in a conventional example.

### DESCRIPTION OF THE REFERENCE NUMERALS

10: LIQUID CRYSTAL DISPLAY DEVICE

11: LIQUID CRYSTAL PANEL

12: PANEL DRIVE CIRCUIT

13: BACKLIGHT

14: BACKLIGHT DRIVE CIRCUIT

15: AREA ACTIVE DRIVE PROCESSING UNIT

16: APL CALCULATING UNIT

21: DISPLAY ELEMENT

22: LED UNIT

23: RED LED

24: GREEN LED

25: BLUE LED

31: INPUT IMAGE

32: LIQUID CRYSTAL DATA

33: LED DATA

34: APL DATA

41: AMBIENT ILLUMINANCE DETECTING UNIT

42: BLU TEMPERATURE DETECTING UNIT

43: MPL CALCULATING UNIT

44: HISTOGRAM GENERATING UNIT

51: DETECTED ILLUMINANCE DATA

52: DETECTED TEMPERATURE DATA

53: MPL DATA

54: HISTOGRAM ANALYSIS RESULT DATA

### BEST MODE FOR CARRYING OUT THE INVENTION

Embodiments of the present invention will be described below with reference to the accompanying drawings.

### 1. First Embodiment

<1.1 Overall Configuration and Operation Overview>

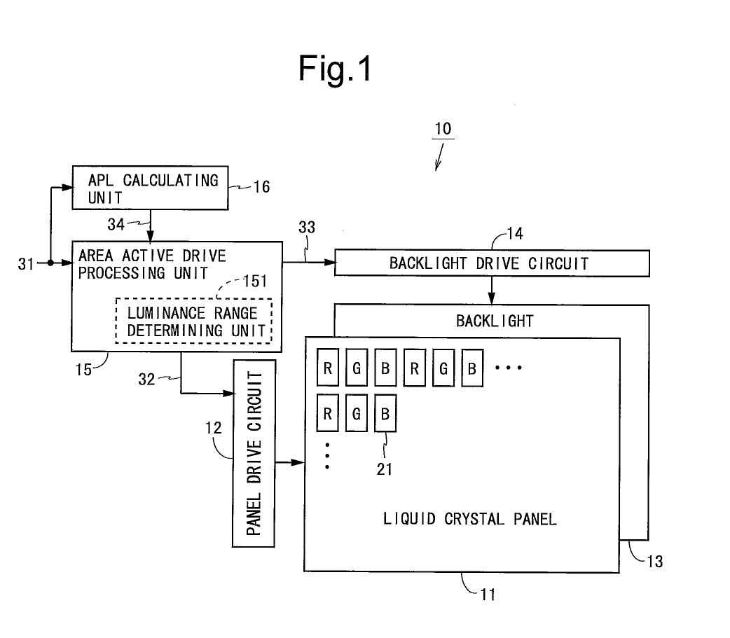

FIG. 1 is a block diagram showing a configuration of a liquid crystal display device 10 according to a first embodiment of the present invention. The liquid crystal display device 10 shown in FIG. 1 includes a liquid crystal panel 11, a panel drive circuit 12, a backlight 13, a backlight drive circuit 14, an area active drive processing unit 15, and an APL calculating unit 16. The area active drive processing unit 15 includes a luminance range determining unit 151. The liquid crystal display device 10 performs area active drive in which the liquid crystal panel 11 is driven, by dividing a screen into a plurality of areas, while the luminances of backlight light sources are controlled based on input images in respective areas. In the following, m and n are integers greater than or equal to 2 and p and q are integers greater than or equal to 1 and at least one of p and q is an integer greater than or equal to 2.

An input image 31 including an R image, a G image, and a B image is inputted into the liquid crystal display device 10. Each of the R image, the G image, and the B image includes the luminances of (m×n) pixels. The input image 31 is provided to the area active drive processing unit 15 and the APL calculating unit 16. The APL calculating unit 16 obtains, based on the input image 31, APL data 34 representing an average luminance level of the image for one frame (hereinafter, referred to as “APL” or “screen average luminance”). The luminance range determining unit 151 determines, based on a data value (calculated average luminance) of the APL data 34, an upper limit value and a lower limit value of the luminances of LEDs 23 to 25 which will be described later. The area active drive processing unit 15 obtains, based on the input image 31, display data (hereinafter, referred to as liquid crystal data 32) which is used to drive the liquid crystal panel 11 and backlight control data (hereinafter, referred to as LED data 33) which is used to drive the backlight 13 (the detail of which will be described later). Note that in the following the data value of the APL data 34 is simply referred to as the “APL value”.

The liquid crystal panel 11 includes (m×n×3) display elements 21. The display elements 21 as a whole are arranged two-dimensionally such that 3m display elements 21 are arranged in a row direction (a horizontal direction in FIG. 1) and n display elements 21 are arranged in a column direction (a vertical direction in FIG. 1). The display elements 21 include R display elements that allow red light to pass therethrough, G display elements that allow green light to pass therethrough, and B display elements that allow blue light to pass therethrough. The R display elements, the G display elements, and the B display elements are arranged side by side in the row direction and three R, G, and B display elements form one pixel.

The panel drive circuit 12 is a drive circuit for the liquid crystal panel 11. The panel drive circuit 12 outputs a signal (voltage signal) for controlling the light transmittances of the display elements 21 to the liquid crystal panel 11, based on the liquid crystal data 32 outputted from the area active drive processing unit 15. The voltage outputted from the panel drive circuit 12 is written into pixel electrodes (not shown) in the respective display elements 21 and the light transmittances of the display elements 21 change according to the voltage written into the pixel electrodes.

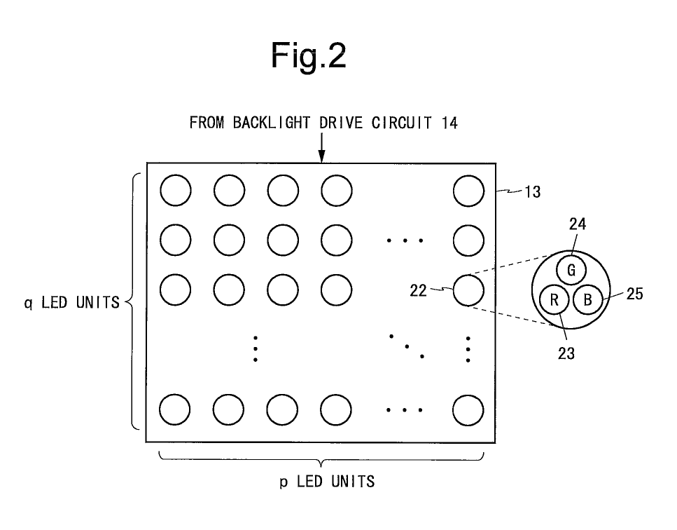

The backlight 13 is provided on the back side of the liquid crystal panel 11 and irradiates backlight light to the back of the liquid crystal panel 11. FIG. 2 is a diagram showing a detail of the backlight 13. As shown in FIG. 2, the backlight 13 includes (p×q) LED units 22. The LED units 22 as a whole are arranged two-dimensionally such that p LED units 22 are arranged in the row direction and q LED units 22 are arranged in the column direction. Each LED unit 22 includes one red LED 23, one green LED 24, and one blue LED 25. Lights emitted from three LEDs 23 to 25 included in one LED unit 22 hit a part of the back of the liquid crystal panel 11.

The backlight drive circuit 14 is a drive circuit for the backlight 13. The backlight drive circuit 14 outputs a signal (a voltage signal or a current signal) for controlling the luminances of the LEDs 23 to 25 to the backlight 13, based on the LED data 33 outputted from the area active drive processing unit 15. The luminances of LEDs 23 to 25 are controlled independently of the luminances of LEDs inside and outside the unit.

A screen of the liquid crystal display device 10 is divided into (p×q) areas and one area is associated with one LED unit 22. The area active drive processing unit 15 obtains, for each of the (p×q) areas, based on an R image in the area, a luminance of a red LED 23 corresponding to the area. Likewise, a luminance of a green LED 24 is determined based on a G image in the area and a luminance of a blue LED 25 is determined based on a B image in the area. The area active drive processing unit 15 obtains luminances of all the LEDs 23 to 25 included in the backlight 13 and outputs LED data 33 representing the obtained LED luminances, to the backlight drive circuit 14.

In addition, the area active drive processing unit 15 obtains, based on the LED data 33, luminances of backlight lights at all the display elements 21 included in the liquid crystal panel 11. Furthermore, the area active drive processing unit 15 obtains light transmittances of all the display elements 21 included in the liquid crystal panel 11, based on the input image 31 and the luminances of the backlight lights, and outputs liquid crystal data 32 representing the obtained light transmittances to the panel drive circuit 12.

In the liquid crystal display device 10, the luminance of an R display element is the product of the luminance of red light emitted from the backlight 13 and the light transmittance of the R display element. Light emitted from one red LED 23 hits a plurality of areas including a corresponding area and areas around the corresponding area. Therefore, the luminance of an R display element is the product of the sum of the luminances of lights emitted from a plurality of red LEDs 23 and the light transmittance of the R display element. Likewise, the luminance of a G display element is the product of the sum of the luminances of lights emitted from a plurality of green LEDs 24 and the light transmittance of the G display element, and the luminance of a B display element is the product of the sum of the luminances of lights emitted from a plurality of blue LEDs 25 and the light transmittance of the B display element.

According to the liquid crystal display device 10 configured in the above-described manner, by obtaining suitable liquid crystal data 32 and LED data 33 based on an input image 31, controlling the light transmittances of the display elements 21 based on the liquid crystal data 32, and controlling the luminances of the LEDs 23 to 25 based on the LED data 33, the input image 31 can be displayed on the liquid crystal panel 11. When the luminance of pixels in an area is low, by reducing the luminance of LEDs 23 to 25 corresponding to the area, the power consumption of the backlight 13 can be reduced. In addition, when the luminance of pixels in an area is low, by switching the luminance of display elements 21 corresponding to the area between lower levels, the resolution of an image can be increased, enabling to improve the image quality of a displayed image.

<1.2 Processing Procedure of the Area Active Drive Processing Unit>

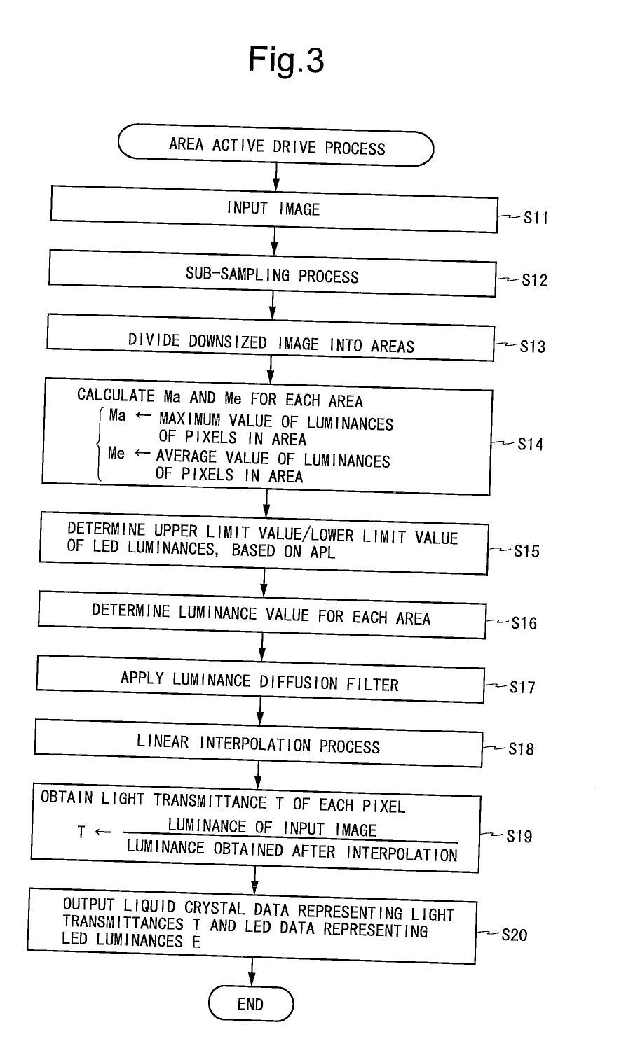

FIG. 3 is a flowchart showing a process of the area active drive processing unit 15. An image of a certain color component (hereinafter, referred to as the color component C) included in an input image 31 is inputted into the area active drive processing unit 15 (step S11). The input image of the color component C includes the luminances of (m×n) pixels.

Then, the area active drive processing unit 15 performs a sub-sampling process (averaging process) on the input image of the color component C and thereby obtains a downsized image including the luminances of (sp×sq) pixels (s is an integer greater than or equal to 2) (step S12). At step S12, the input image of the color component C is downsized by a factor of (sp/m) in the horizontal direction and a factor of (sq/n) in the vertical direction. Then, the area active drive processing unit 15 divides the downsized image into (p×q) areas (step S13). Each area includes the luminances of (s×s) pixels. Then, the area active drive processing unit 15 obtains, for each of the (p×q) areas, a maximum value Ma of the luminances of pixels in the area and an average value Me of the luminances of pixels in the area (step S14).

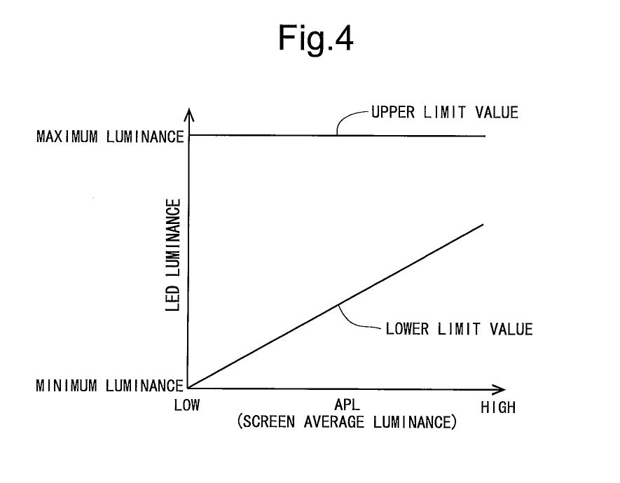

Then, the luminance range determining unit 151 in the area active drive processing unit 15 determines an upper limit value and a lower limit value of LED luminances, based on a data value of APL data 34 obtained by the APL calculating unit 16 (step S15). In the present embodiment, APL and the upper limit value/lower limit value of LED luminances are associated with each other in advance, as shown in FIG. 4. In an example shown in FIG. 4, the upper limit value of LED luminances is constant (maximum luminance) regardless of the magnitude of the APL value. On the other hand, the lower limit value of LED luminances changes according to the APL value. Specifically, with reference to a minimum APL, as the APL value increases, the lower limit value of LED luminances gradually increases from a minimum luminance. By determining the upper limit value/lower limit value of LED luminances in the above-described manner, as the APL increases, i.e., as the overall screen gets brighter, the difference in luminance between the areas decreases.

Then, the area active drive processing unit 15 obtains, for each of the (p×q) areas, an LED luminance (step S16). Methods of determining the LED luminance include, for example, a method of determining based on a maximum value Ma of the luminances of pixels in an area, a method of determining based on an average value Me of the luminances of pixels in an area, and a method of determining by performing weighted averaging of a maximum value Ma and an average value Me of the luminances of pixels in an area. Here, the LED luminance is a luminance (value) within a range between the upper limit value and the lower limit value which are obtained at step S15. Therefore, for example, when an LED luminance obtained by a method based on a maximum value Ma of the luminances of pixels in an area is lower than the lower limit value obtained at step S15, the lower limit value is set as a LED luminance at step S16.

Then, the area active drive processing unit 15 applies a luminance diffusion filter (dot diffusion filter) to the (p×q) LED luminances obtained at step S16 and thereby obtains first backlight luminance data including (tp×tq) luminances (t is an integer greater than or equal to 2) (step S17). At step S17, the (p×q) LED luminances are upsized by a factor of t in both the horizontal direction and the vertical direction.

Then, the area active drive processing unit 15 performs a linear interpolation process on the first backlight luminance data and thereby obtains second backlight luminance data including (m×n) luminances (step S18). At step S18, the first backlight luminance data is upsized by a factor of (m/tp) in the horizontal direction and a factor of (n/tq) in the horizontal direction. The second backlight luminance data represents the luminances of backlight lights of the color component C that enter (m×n) display elements 21 of the color component C when (p×q) LEDs of the color component C emit lights at the luminances obtained at step S16.

Then, the area active drive processing unit 15 divides the luminances of the (m×n) pixels included in the input image of the color component C by the (m×n) luminances included in the second backlight luminance data, respectively, and thereby obtains light transmittances T of the (m×n) display elements 21 of the color component C (step S19).

Finally, the area active drive processing unit 15 outputs, for the color component C, liquid crystal data 32 representing the (m×n) light transmittances which are obtained at step S19 and LED data 33 representing the (p×q) LED luminances which are obtained at step S16 (step S20). At this time, the liquid crystal data 32 and the LED data 33 are converted into values in a suitable range, in accordance with the specifications of the panel drive circuit 12 and the backlight drive circuit 14.

The area active drive processing unit 15 performs a process shown in FIG. 3 on an R image, a G image, and a B image and thereby obtains, based on an input image 31 including the luminances of (m×n×3) pixels, liquid crystal data 32 representing (m×n×3) transmittances and LED data 33 representing (p×q×3) LED luminances.

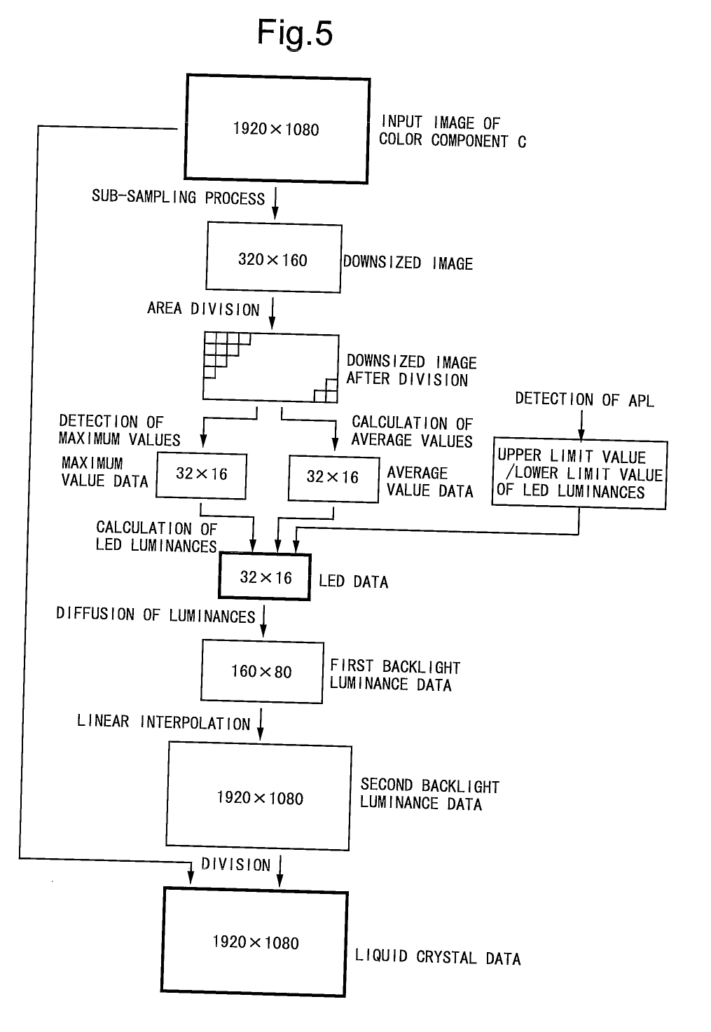

FIG. 5 is a diagram showing the process of obtaining liquid crystal data and LED data for the case in which m=1920, n=1080, p=32, q=16, s=10 and t=5. As shown in FIG. 5, by performing a sub-sampling process on an input image of a color component C which includes the luminances of (1920×1080) pixels, a downsized image including the luminances of (320×160) pixels is obtained. The downsized image is divided into (32×16) areas (the area size is (10×10) pixels). By obtaining a maximum value Ma and an average value Me of the luminances of pixels for each area, maximum value data including the (32×16) maximum values and average value data including the (32×16) average values are obtained. In addition, an upper limit value and a lower limit value of LED luminances are determined based on an APL value. Then, taking into account the upper limit value/lower limit value, LED data for the color component C which represents (32×16) LED luminances is obtained based on the maximum value data or based on the average value data or based on the maximum value data and the average value data.

By applying a luminance diffusion filter to the LED data for the color component C, first backlight luminance data including (160×80) luminances is obtained. By performing a linear interpolation process on the first backlight luminance data, second backlight luminance data including (1920×1080) luminances is obtained. Finally, by dividing the luminances of the pixels included in the input image by the luminances included in the second backlight luminance data, liquid crystal data for the color component C which includes (1920×1080) light transmittances is obtained.

Note that although in FIG. 3, for simplification of description, the area active drive processing unit 15 performs processes for images of the respective color components in turn, the processes for images of the respective color components may be performed in a time-division manner. Note also that although in FIG. 3 the area active drive processing unit 15 performs a sub-sampling process on an input image to remove noise and performs area active drive based on a downsized image, the area active drive processing unit 15 may perform area active drive based on an original input image.

<1.3 Effects>

According to the present embodiment, in a liquid crystal display device that performs area active drive, when the luminance of LEDs corresponding to each area is obtained, the upper limit value/lower limit value of LED luminances are determined in advance based on an average luminance level of an image. Specifically, as shown in FIG. 4, the lower the APL value the lower the lower limit value of LED luminances, and the higher the APL value the higher the lower limit value of LED luminances. As such, as the APL value increases, the lower limit value of LED luminances gradually increases from a minimum luminance. Thus, as the overall screen gets brighter, the difference in luminance between the maximum value and minimum value of LED luminances which can appear in one frame decreases. By this, even if the luminance of LEDs in each area changes every frame by displaying a moving image, the difference in luminance between the areas decreases over conventional cases, and accordingly, the occurrence of flicker is suppressed. In addition, when the APL value is low, the difference in luminance between the maximum value and minimum value of LED luminances which can appear in one frame increases. Hence, when display of an overall dark image is performed, high contrast is obtained.

<1.4 Variants>

Although, in the first embodiment, the correspondence relationship between APL and the upper limit value/lower limit value of LED luminances is as shown in FIG. 4, the present invention is not limited thereto. Variants of the correspondence relationship are shown below.

<1.4.1 First Variant>

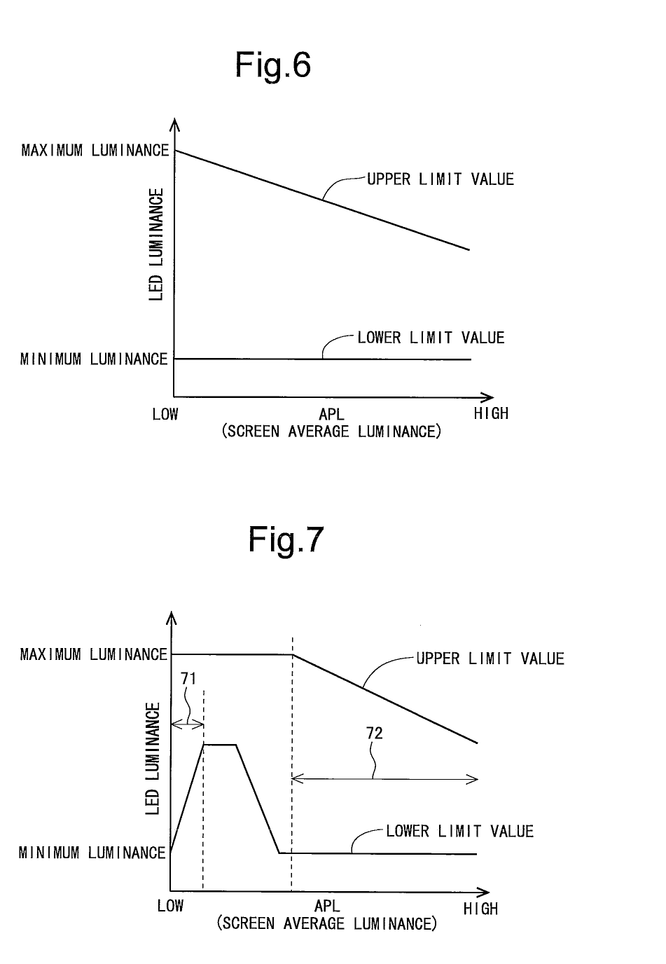

FIG. 6 is a diagram showing a first variant of the correspondence relationship between APL and the upper limit value/lower limit value of LED luminances. In the present variant, the lower limit value of LED luminances is constant (minimum luminance) regardless of the magnitude of the APL value. On the other hand, the upper limit value of LED luminances changes according to the APL value. Specifically, with reference to a minimum APL, as the APL value increases, the upper limit value of LED luminances gradually decreases from a maximum luminance. That is, as the overall screen gets brighter, the upper limit value of LED luminances gradually decreases.

According to the present variant, as the overall screen gets brighter, the difference in luminance between the maximum value and minimum value of LED luminances which can appear in one frame decreases. By this, as in the first embodiment, the occurrence of flicker is suppressed upon displaying a moving image. In addition, as the overall screen gets brighter, the upper limit value of LED luminances decreases, and thus, power consumption is reduced and the amount of heat is also reduced. Furthermore, the glare perceived when display of an overall bright image is performed is lessened. Moreover, when the APL value is low, the difference in luminance between the maximum value and minimum value of LED luminances which can appear in one frame increases. Thus, as in the first embodiment, when display of an overall dark image is performed, high contrast is obtained.

<1.4.2 Second Variant>

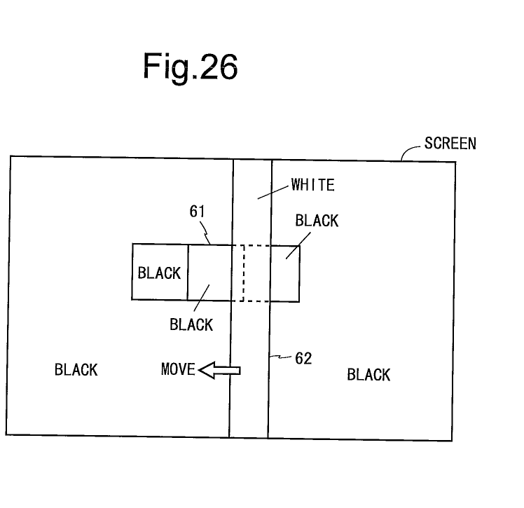

FIG. 7 is a diagram showing a second variant of the correspondence relationship between APL and the upper limit value/lower limit value of LED luminances. In the present variant, when APL is low (when APL is in a range indicated by reference numeral 71), as the APL value increases, the lower limit value of LED luminances increases from a minimum luminance at a relatively high rate. For example, when the state transitions from one in which a completely dark image is displayed to one in which a white bar such as that shown in FIG. 26 is displayed, APL increases slightly. Thus, when the correspondence relationship between APL and the upper limit value/lower limit value of LED luminances is such as that shown in FIG. 4, the difference in luminance between the areas does not decrease much. On the other hand, with the correspondence relationship shown in FIG. 7, by the increase in the lower limit value of LED luminances, the difference in luminance between the areas effectively decreases and thus the occurrence of flicker is effectively suppressed.

When APL is relatively high (when APL is in a range indicated by reference numeral 72), as the APL value increases, the upper limit value of LED luminances gradually decreases from a maximum luminance. By this, as in the first variant, effects such as a reduction in power consumption, a reduction in the amount of heat, and a lessening of glare are obtained.

### 2. Second Embodiment

<2.1 Overall Configuration and Processing Procedure>

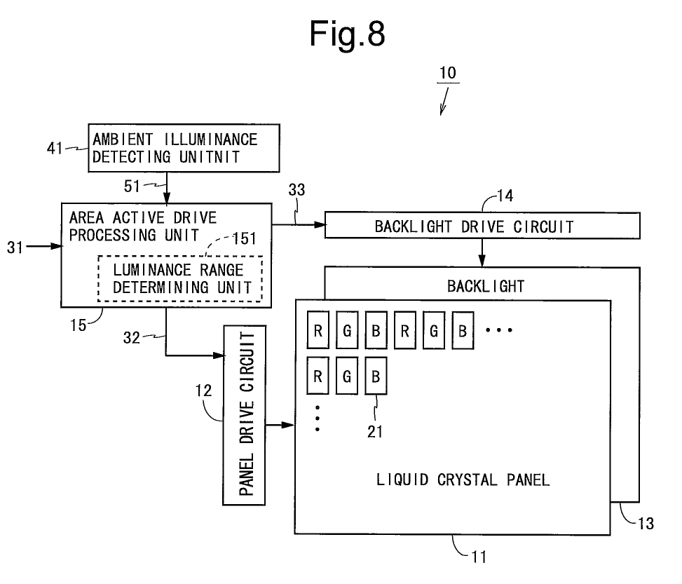

FIG. 8 is a block diagram showing a configuration of a liquid crystal display device 10 according to a second embodiment of the present invention. In the present embodiment, an ambient illuminance detecting unit 41 is provided in place of an APL calculating unit 16 in the first embodiment. Note that the configuration is the same as that in the first embodiment except for the ambient illuminance detecting unit 41 and thus description thereof is omitted.

The ambient illuminance detecting unit 41 detects an ambient brightness (illuminance) of the liquid crystal display device 10 and outputs a value indicating the detected illuminance, as detected illuminance data 51. A luminance range determining unit 151 determines an upper limit value and a lower limit value of LED luminances, based on a data value of the detected illuminance data 51. Note that in the following the data value of the detected illuminance data 51 is simply referred to as the “detected illuminance”.

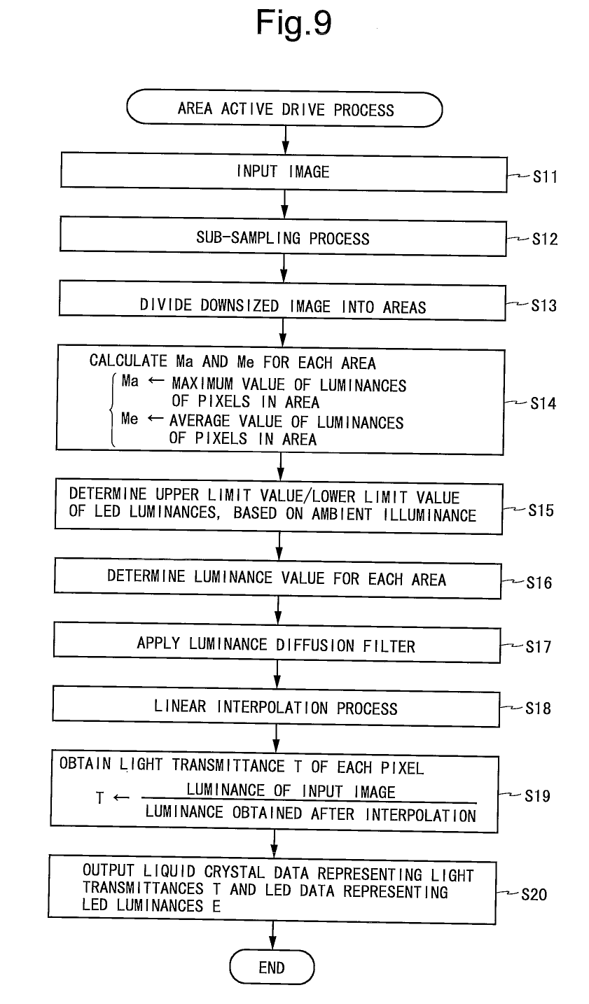

FIG. 9 is a flowchart showing a process of an area active drive processing unit 15 according to the present embodiment. In the present embodiment, at step S15, the luminance range determining unit 151 in the area active drive processing unit 15 determines an upper limit value and a lower limit value of LED luminances, based on a data value (detected illuminance) of detected illuminance data 51 which is outputted from the ambient illuminance detecting unit 41. Note that the contents of processes at all steps other than step S15 are the same as those in the first embodiment and thus description thereof is omitted.

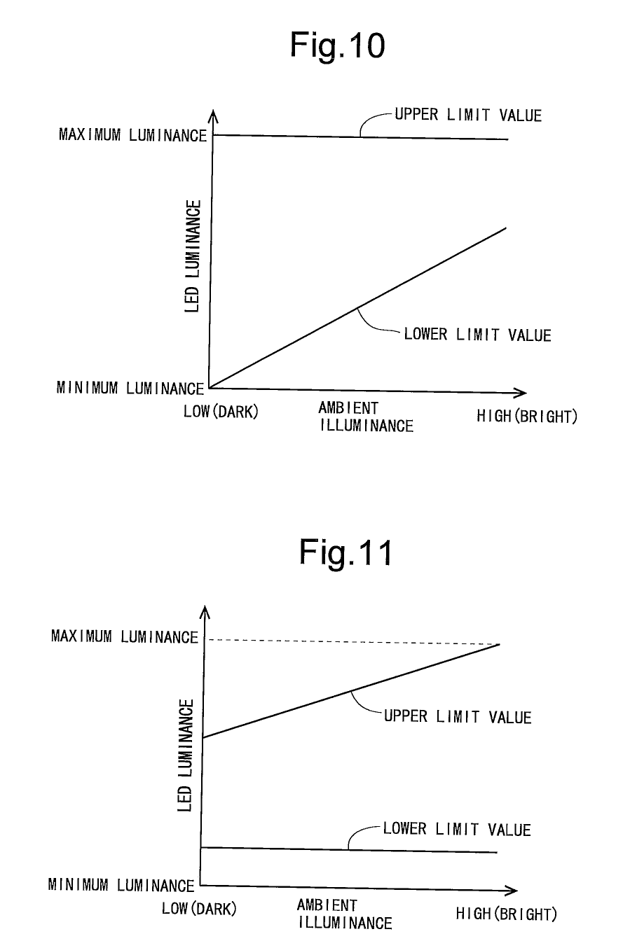

In the present embodiment, ambient illuminance and the upper limit value/lower limit value of LED luminances are associated with each other in advance, as shown in FIG. 10. In an example shown in FIG. 10, the upper limit value of LED luminances is constant (maximum luminance) regardless of the magnitude of the detected illuminance. On the other hand, the lower limit value of LED luminances changes according to the detected illuminance. Specifically, with reference to a minimum ambient illuminance, as the detected illuminance increases, the lower limit value of LED luminances gradually increases from a minimum luminance.

<2.2 Effects>

According to the present embodiment, as the detected illuminance increases, the lower limit value of LED luminances increases. Thus, as the surroundings of the liquid crystal display device get brighter, the difference in luminance between the maximum value and minimum value of LED luminances which can appear in one frame decreases. By this, when the liquid crystal display device is used in a bright environment, the occurrence of flicker upon displaying a moving image is suppressed. In addition, when the surroundings (usage environment) of the liquid crystal display device are dark, the difference in luminance between the maximum value and minimum value of LED luminances which can appear in one frame increases, and thus, high contrast is obtained.

<2.3 Variants>

Although, in the first embodiment, the correspondence relationship between ambient illuminance and the upper limit value/lower limit value of LED luminances is as shown in FIG. 10, the present invention is not limited thereto. Variants of the correspondence relationship are shown below.

<2.3.1 First Variant>

FIG. 11 is a diagram showing a first variant of the correspondence relationship between ambient illuminance and the upper limit value/lower limit value of LED luminances. In the present variant, the lower limit value of LED luminances is constant (minimum luminance) regardless of the magnitude of the detected illuminance. On the other hand, the upper limit value of LED luminances changes according to the detected illuminance. Specifically, with reference to a maximum ambient illuminance, as the detected illuminance decreases, the upper limit value of LED luminances gradually decreases from a maximum luminance.

According to the present variant, as the ambient illuminance decreases, the upper limit value of LED luminances decreases. Thus, as the surroundings of the liquid crystal display device get darker, the difference in luminance between the maximum value and minimum value of LED luminances which can appear in one frame decreases. By this, when the liquid crystal display device is used in a dark environment, the occurrence of flicker upon displaying a moving image is suppressed. In addition, the glare perceived when the liquid crystal display device is used in a dark environment is lessened.

<2.3.2. Second Variant>

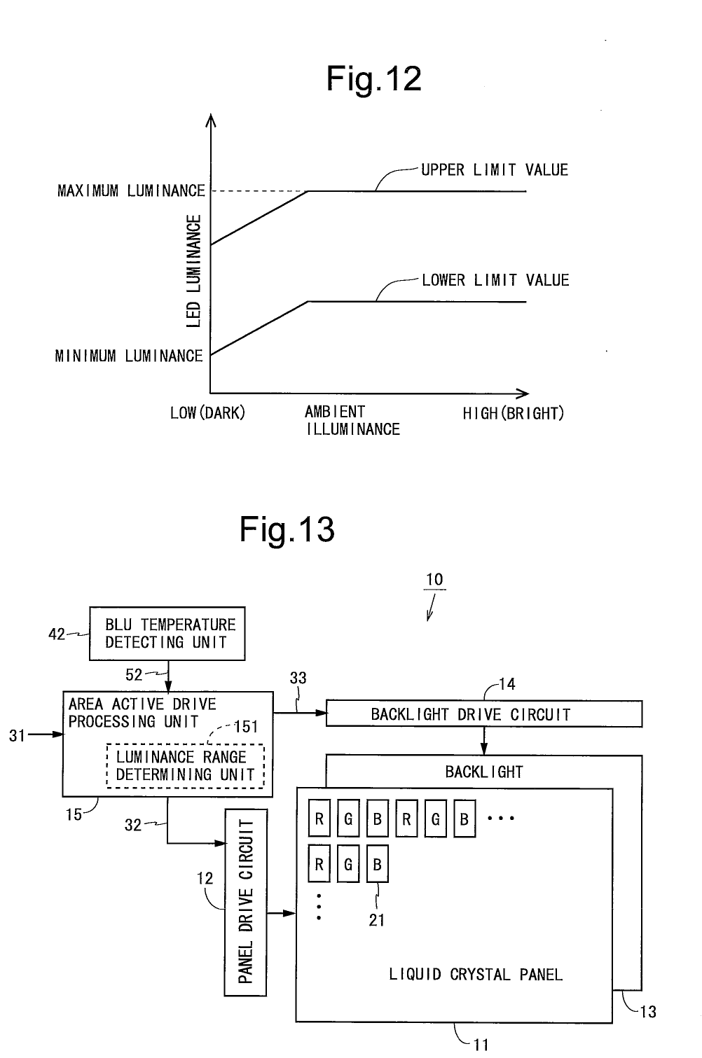

FIG. 12 is a diagram showing a second variant of the correspondence relationship between ambient illuminance and the upper limit value/lower limit value of LED luminances. In the present variant, when the ambient illuminance has a predetermined value or less, the upper limit value/lower limit value of LED luminances change according to the detected illuminance; and when the ambient illuminance has the predetermined value or more, the upper limit value/lower limit value of LED luminances are constant regardless of the detected illuminance. Specifically, with reference to an ambient illuminance having the predetermined value, the upper limit value of LED luminances gradually decreases from a maximum luminance as the detected illuminance decreases. On the other hand, with reference to a minimum ambient illuminance, the lower limit value of LED luminances gradually increases from a minimum luminance as the detected illuminance increases, until the detected illuminance reaches the predetermined value.

In the present variant, regardless of the ambient illuminance, the difference in luminance between the maximum value and minimum value of LED luminances which can appear in one frame decreases over conventional cases. Thus, the occurrence of flicker upon displaying a moving image is suppressed regardless of the usage environment of the liquid crystal display device. In addition, when the detected illuminance is low, the upper limit value of LED luminances decreases, and thus, the glare perceived when the liquid crystal display device is used in a dark environment is lessened. Furthermore, when the detected illuminance is low, the lower limit value of LED luminances decreases. Thus, when the liquid crystal display device is used in a dark environment, high contrast is obtained.

### 3. Third Embodiment

<3.1 Overall Configuration and Processing Procedure>

FIG. 13 is a block diagram showing a configuration of a liquid crystal display device 10 according to a third embodiment of the present invention. In the present embodiment, a BLU temperature detecting unit 42 is provided in place of an APL calculating unit 16 in the first embodiment. Note that the configuration is the same as that in the first embodiment except for the BLU temperature detecting unit 42 and thus description thereof is omitted.

The BLU temperature detecting unit 42 detects a temperature (hereinafter, referred to as the “BLU temperature”) of a backlight 13 provided in the liquid crystal display device 10, and outputs a value indicating the detected temperature as detected temperature data 52. A luminance range determining unit 151 determines an upper limit value and a lower limit value of LED luminances, based on a data value of the detected temperature data 52. Note that in the following the data value of the detected temperature data 52 is simply referred to as the “detected temperature”.

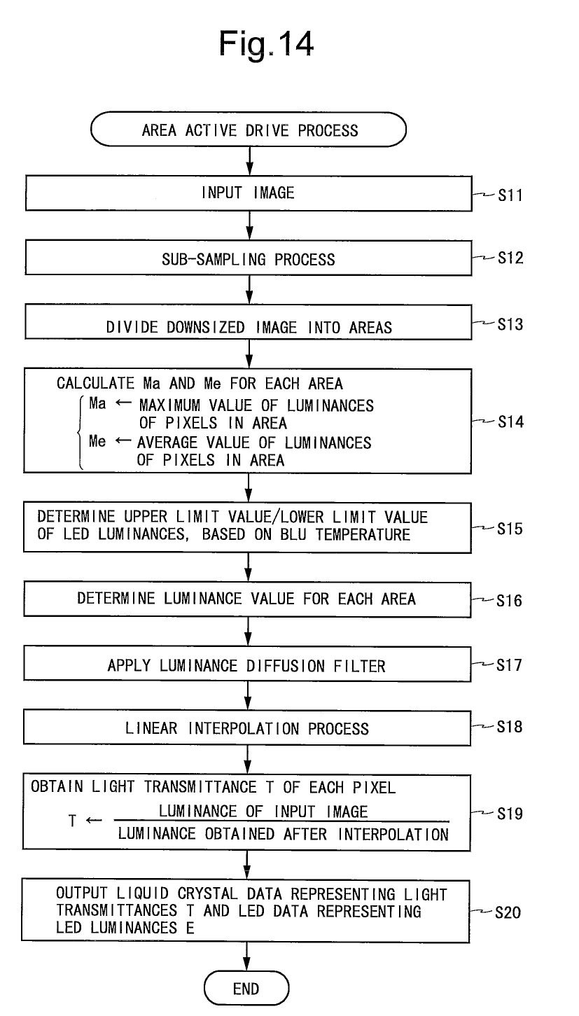

FIG. 14 is a flowchart showing a process of an area active drive processing unit 15 according to the present embodiment. In the present embodiment, at step S15, the luminance range determining unit 151 in the area active drive processing unit 15 determines an upper limit value and a lower limit value of LED luminances, based on a data value (detected temperature) of detected temperature data 52 which is outputted from the BLU temperature detecting unit 42. Note that the contents of processes at all steps other than step S15 are the same as those in the first embodiment and thus description thereof is omitted.

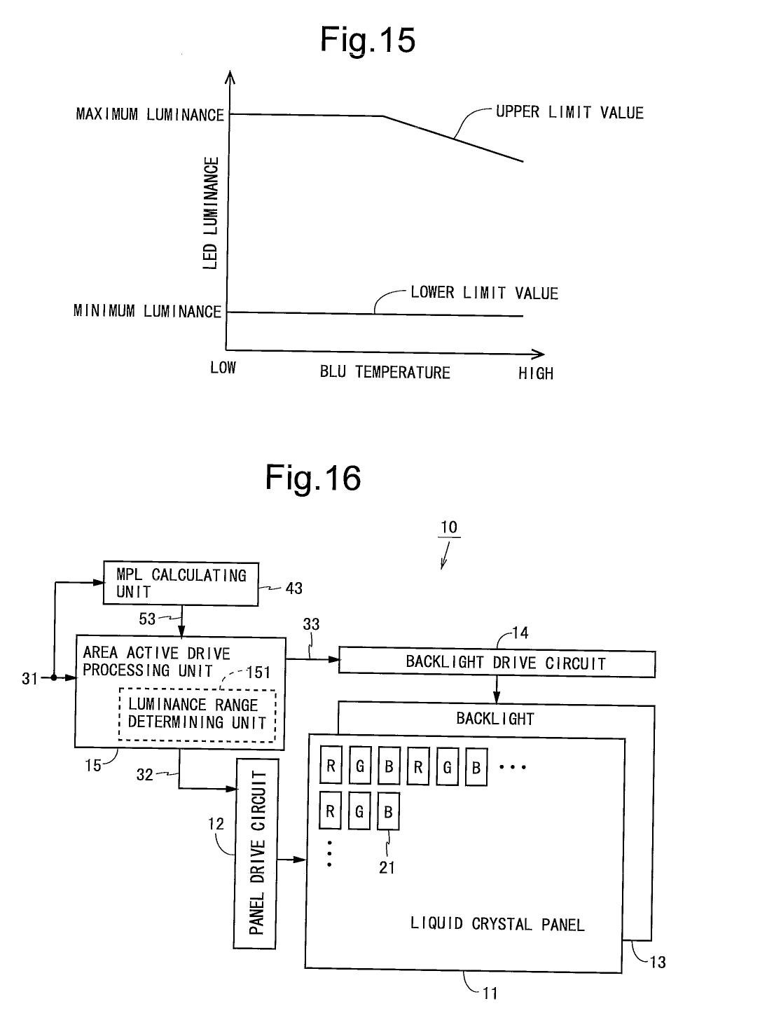

In the present embodiment, BLU temperature and the upper limit value/lower limit value of LED luminances are associated with each other in advance, as shown in FIG. 15. In an example shown in FIG. 15, the lower limit value of LED luminances is constant (minimum luminance) regardless of the magnitude of the detected temperature. On the other hand, the upper limit value of LED luminances is constant (maximum luminance) when the BLU temperature has a predetermined value or less, and changes according to the detected temperature when the BLU temperature has the predetermined value or more. Specifically, with reference to a BLU temperature having the predetermined value, as the detected temperature increases, the upper limit value of LED luminances gradually decreases.

<3.2 Effects>

According to the present embodiment, when the temperature of the backlight reaches a predetermined temperature or higher, as the temperature of the backlight increases, the upper limit value of LED luminances decreases. Thus, thermal runaway caused by an increase in the temperature of the backlight is suppressed and power consumption is reduced. In addition, when the temperature of the backlight is low, the upper limit value of LED luminances increases and thus lack of luminance is suppressed.

### 4. Fourth Embodiment

<4.1 Overall Configuration and Processing Procedure>

FIG. 16 is a block diagram showing a configuration of a liquid crystal display device 10 according to a fourth embodiment of the present invention. In the present embodiment, an MPL calculating unit 43 is provided in place of an APL calculating unit 16 in the first embodiment. Note that the configuration is the same as that in the first embodiment except for the MPL calculating unit 43 and thus description thereof is omitted.

The MPL calculating unit 43 determines for each area whether an image in the area is a moving image or a still image and thereby obtains MPL data 53 representing the ratio of the number of moving image areas to the total number of areas (hereinafter, referred to as the “MPL” or “screen moving image ratio”), based on an input image 31. A luminance range determining unit 151 determines an upper limit value and a lower limit value of LED luminances, based on a data value (calculated screen moving image ratio) of the MPL data 53. Note that in the following the data value of the MPL data 53 is simply referred to as the “MPL value”.

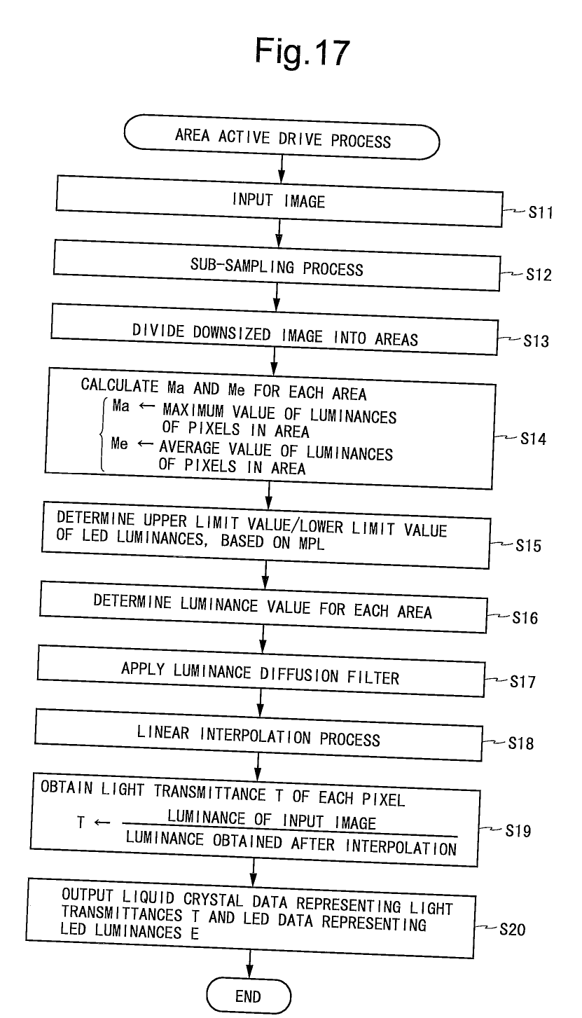

FIG. 17 is a flowchart showing a process of an area active drive processing unit 15 according to the present embodiment. In the present embodiment, at step S15, the luminance range determining unit 151 in the area active drive processing unit 15 determines an upper limit value and a lower limit value of

LED luminances, based on an MPL value obtained by the MPL calculating unit 43. Note that the contents of processes at all steps other than step S15 are the same as those in the first embodiment and thus description thereof is omitted.

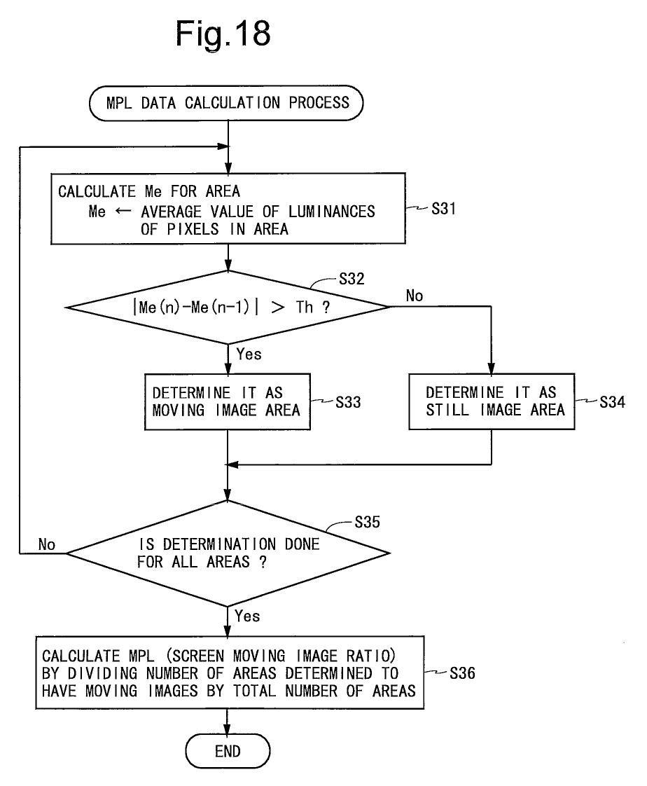

Now, a calculation procedure of MPL data 53 according to the present embodiment will be described. FIG. 18 is a flowchart showing a process of the MPL calculating unit 43. The MPL calculating unit 43 obtains, for one of the above-described (p×q) areas, an average value Me of the luminances of pixels in the area (step S31). Note that by repeating processes at steps S31 to S35 as will be described later, at the time of proceeding to step S36 average values Me are obtained for all the (p×q) areas. Note also that in the following an average value that is obtained in a process in a current frame is indicated by “Me (n)” and an average value obtained in a process in a frame preceding the current frame (immediately preceding frame) is indicated by “Me(n−1)”.

The MPL calculating unit 43 then determines whether the difference between the average value Me (n) for the current frame and the average value Me(n−1) for the immediately preceding frame is greater than a predetermined threshold value Th (step S32). As a result, if the difference between Me (n) and Me (n−1) is greater than the threshold value Th, then the MPL calculating unit 43 determines that the area is a moving image area (step S33). On the other hand, if the difference between Me(n) and Me(n−1) is less than or equal to the threshold value Th, then the MPL calculating unit 43 determines that the area is a still image area (step S34). Note that the threshold value Th can be set to any value.

Then, the MPL calculating unit 43 determines whether a determination as to whether an area is a moving image area or a still image area is done for all the (p×q) areas. As a result, if the determination is done then processing proceeds to step S36, and if not done then processing returns to step S31. In this manner, the processes at steps S31 to S35 are repeated (p×q) times.

At step S36, the MPL calculating unit 43 calculates MPL (screen moving image ratio) by dividing the number of areas that are determined to be moving image areas by the total number of areas. At step S15 shown in FIG. 17, an upper limit value and a lower limit value of LED luminances are determined based on the thus calculated MPL.

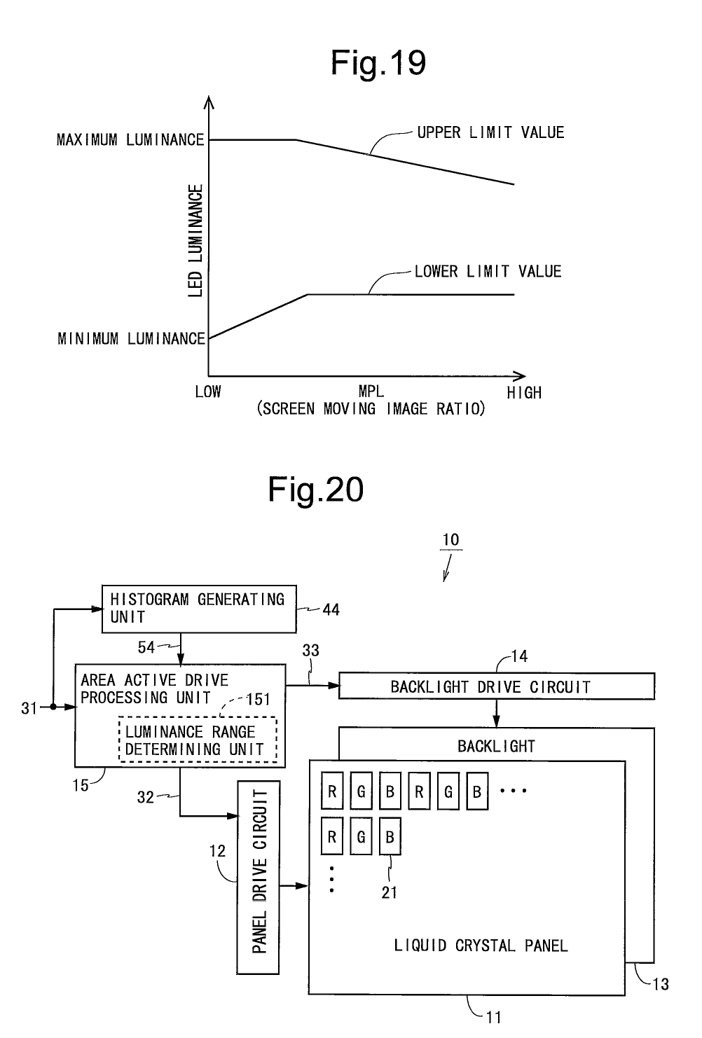

In the present embodiment, MPL and the upper limit value/lower limit value of LED luminances are associated with each other in advance, as shown in FIG. 19. In an example shown in FIG. 19, the upper limit value of LED luminances is constant (maximum luminance) when the MPL value is less than or equal to a predetermined value, and changes according to the MPL value when the MPL value is greater than or equal to the predetermined value. Specifically, with reference to an MPL having the predetermined value, as the MPL value increases, the upper limit value of LED luminances gradually decreases from the maximum luminance. On the other hand, the lower limit value of LED luminances is constant when the MPL value is greater than or equal to the predetermined value, and changes according to the MPL value when the MPL value is less than or equal to the predetermined value. Specifically, with reference to a minimum MPL, the lower limit value of LED luminances gradually increases from a minimum luminance as the MPL value increases, until the MPL value reaches the predetermined value.

<4.2 Effects>

According to the present embodiment, as the MPL value increases, the difference in luminance between the maximum value and minimum value of LED luminances which can appear in one frame decreases. That is, as the number of moving images increases on a screen, the difference in luminance between the areas decreases. Accordingly, flicker upon displaying a moving image is effectively suppressed.

### 5. Fifth Embodiment

<5.1 Overall Configuration and Processing Procedure>

FIG. 20 is a block diagram showing a configuration of a liquid crystal display device 10 according to a fifth embodiment of the present invention. In the present embodiment, a histogram generating unit 44 is provided in place of an APL calculating unit 16 in the first embodiment. Note that the configuration is the same as that in the first embodiment except for the histogram generating unit 44 and thus description thereof is omitted.

The histogram generating unit 44 generates, based on an input image 31, a histogram representing a luminance distribution of the image for one frame. The histogram generating unit 44 then analyzes, based on the histogram, a trend of the image (e.g., an “overall bright image”, an “overall dark image”, an “image where high luminance and low luminance are mixed”, etc.) and outputs a result of the analysis as histogram analysis result data 54. A luminance range determining unit 151 determines an upper limit value and a lower limit value of LED luminances, based on the histogram analysis result data 54.

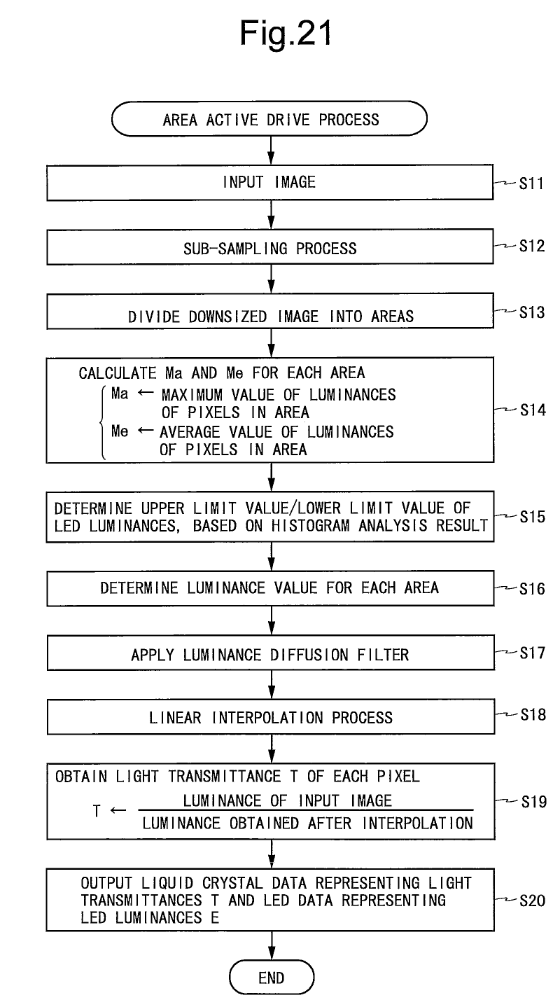

FIG. 21 is a flowchart showing a process of an area active drive processing unit 15 according to the present embodiment. In the present embodiment, at step S15, the luminance range determining unit 151 in the area active drive processing unit 15 determines an upper limit value and a lower limit value of LED luminances, based on histogram analysis result data 54 which is outputted from the histogram generating unit 44. Note that the contents of processes at all steps other than step S15 are the same as those in the first embodiment and thus description thereof is omitted.

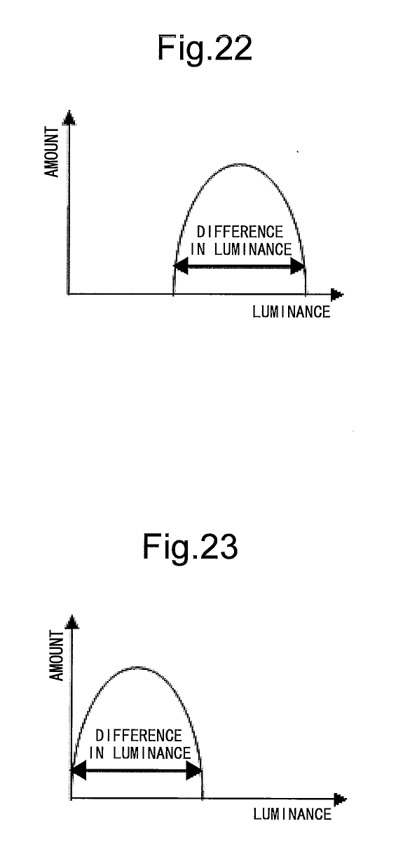

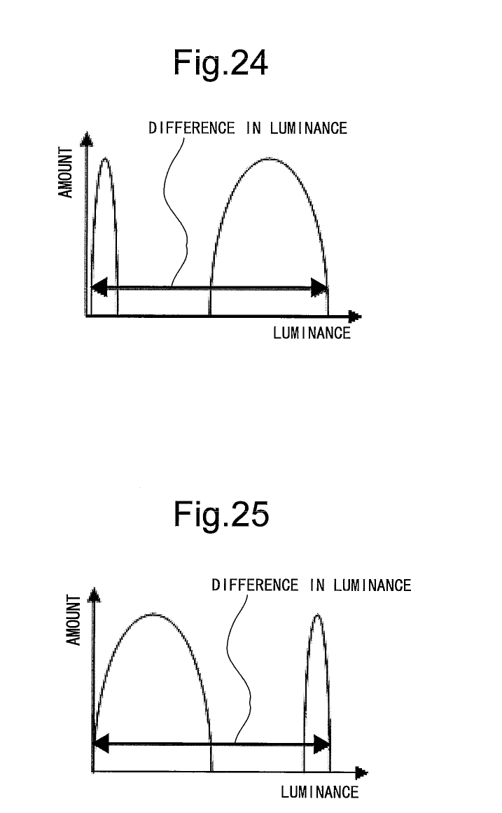

Next, the relationship between a histogram generated by the histogram generating unit 44 and the upper limit value/lower limit value of LED luminances will be described using examples. When the histogram is such as that shown in FIG. 22 (first example), it is grasped that the image is an overall bright image. At this time, since the difference in luminance between the areas is relatively small, flicker caused by displaying a moving image is less likely to be visually recognized. Thus, the lower limit value of LED luminances is set to a low value. When the histogram is such as that shown in FIG. 23 (second example), it is grasped that the image is an overall dark image. At this time, since the difference in luminance between the areas is relatively small, flicker caused by displaying a moving image is less likely to be visually recognized. Thus, the lower limit value of LED luminances is set to a low value. When the histogram is such as that shown in FIG. 24 (third example), a high luminance image and a low luminance image are mixed and it is grasped that there is relatively more high luminance image. At this time, although the difference in luminance between the areas is relatively large, since display of an overall bright image is performed, flicker caused by displaying a moving image is less likely to be visually recognized. Hence, the lower limit value of LED luminances is set to a low value. When the histogram is such as that shown in FIG. 25 (fourth example), a high luminance image and a low luminance image are mixed and it is grasped that there is relatively more low luminance image. At this time, the difference in luminance between the areas is relatively large and display of an overall dark image is performed. Thus, flicker caused by displaying a moving image is likely to be visually recognized. Hence, the lower limit value of LED luminances is set to a high value.

<5.2 Effects>

According to the present embodiment, the upper limit value/lower limit value of LED luminances are determined based on a luminance distribution of an input image. Namely, as in the first to fourth examples, the upper limit value/lower limit value of LED luminances can be changed according to the overall trend of an image. Hence, when an image where flicker is likely to be visually recognized is displayed, the upper limit value/lower limit value of LED luminances can be determined in advance such that the difference in luminance between the areas decreases. Accordingly, the occurrence of flicker is effectively suppressed.

<6. Others>

Although in the above-described embodiments a backlight 13 is configured by red LEDs 23, green LEDs 24, and blue LEDs 25, the backlight may be configured by white LEDs, Cold Cathode Fluorescent Lamps (CCFLs), etc. When the backlight is configured by white LEDs, an area active drive processing unit 15 may, for example, generate a Y image (luminance image) based on an R image, a G image, and a B image, perform steps S11 to S18 in the process shown in FIG. 3 on the Y image, and perform step S19 on combinations of each of the three color images and the Y image.

Although in the above-described embodiments an LED unit 22 includes one red LED 23, one green LED 24, and one blue LED 25, the number of LEDs of three colors included in an LED unit 22 may be other than that. For example, an LED unit 22 may include one red LED 23, one blue LED 25, and two green LEDs 24. In this case, a backlight drive circuit 14 controls the two green LEDs 24 such that the sum of the luminances of the two green LEDs 24 is an LED luminance determined at step S16.

The frame rate of a liquid crystal display device may be any; for example, the frame rate may be 30 Hz or 60 Hz or 120 Hz or higher. The higher the frame rate, the smaller the units in which the luminances of LEDs change, and thus flicker becomes less noticeable. In addition, in any image display device including a backlight, by determining an upper limit value and a lower limit value of LED luminances in the above-described manner, the same effects as those obtained by a liquid crystal display device can be obtained.

1. An image display device having a function of controlling a luminance of a backlight, the image display device comprising:
a display panel including a plurality of display elements;
a backlight including a plurality of light sources;
a signal processing unit that obtains display data and backlight control data, based on an input image;
a luminance range determining unit that determines an upper limit value and a lower limit value of luminances of the light sources;
a panel drive circuit that outputs a signal for controlling light transmittances of the display elements to the display panel, based on the display data; and
a backlight drive circuit that outputs a signal for controlling the luminances of the light sources to the backlight, based on the backlight control data, wherein
when the signal processing unit obtains the backlight control data, the signal processing unit divides the input image into a plurality of areas and obtains a luminance of light sources corresponding to each area, within a range between the upper limit value and the lower limit value which are determined by the luminance range determining unit.

2. The image display device according to claim 1, further comprising an average luminance calculating unit that calculates an average luminance of the input image for one screen, wherein
the luminance range determining unit determines an upper limit value and a lower limit value of luminances of the light sources, based on the calculated average luminance which is the average luminance calculated by the average luminance calculating unit.

3. The image display device according to claim 2, wherein the luminance range determining unit determines a lower limit value of luminances of the light sources such that as the calculated average luminance increases the lower limit value increases.

4. The image display device according to claim 2, wherein the luminance range determining unit determines an upper limit value of luminances of the light sources such that as the calculated average luminance increases the upper limit value decreases.

5. The image display device according to claim 1, further comprising an illuminance detecting unit that detects an illuminance received by the display panel, wherein
the luminance range determining unit determines an upper limit value and a lower limit value of luminances of the light sources, based on the detected illuminance which is the illuminance detected by the illuminance detecting unit.

6. The image display device according to claim 5, wherein the luminance range determining unit determines a lower limit value of luminances of the light sources such that as the detected illuminance increases the lower limit value increases.

7. The image display device according to claim 5, wherein the luminance range determining unit determines an upper limit value of luminances of the light sources such that as the detected illuminance decreases the upper limit value decreases.

8. The image display device according to claim 5, wherein when the detected illuminance is lower than or equal to a predetermined illuminance, the luminance range determining unit determines an upper limit value of luminances of the light sources such that as the detected illuminance decreases the upper limit value decreases, and determines a lower limit value of luminances of the light sources such that as the detected illuminance increases the lower limit value increases.

9. The image display device according to claim 1, further comprising a temperature detecting unit that detects a temperature of the backlight, wherein
the luminance range determining unit determines an upper limit value and a lower limit value of luminances of the light sources, based on the detected temperature which is the temperature detected by the temperature detecting unit.

10. The image display device according to claim 9, wherein when the detected temperature is higher than or equal to a predetermined temperature, the luminance range determining unit determines an upper limit value of luminances of the light sources such that as the detected temperature increases the upper limit value decreases.

11. The image display device according to claim 1, further comprising a moving image ratio calculating unit that determines for each area whether an image in the area is a moving image or a still image and calculates, as a screen moving image ratio, a ratio of a number of areas that are determined to have moving images to a number of the plurality of areas, based on the input image, wherein
the luminance range determining unit determines an upper limit value and a lower limit value of luminances of the light sources, based on the calculated screen moving image ratio which is the screen moving image ratio calculated by the moving image ratio calculating unit.

12. The image display device according to claim 11, wherein when the calculated screen moving image ratio is lower than or equal to a predetermined value, the luminance range determining unit determines a lower limit value of luminances of the light sources such that as the calculated screen moving image ratio increases the lower limit value increases; and when the calculated screen moving image ratio is higher than or equal to the predetermined value, the luminance range determining unit determines an upper limit value of luminances of the light sources such that as the calculated screen moving image ratio increases the upper limit value decreases.

13. The image display device according to claim 1, further comprising a histogram generating unit that generates a histogram representing a luminance distribution of the input image, wherein
the luminance range determining unit determines an upper limit value and a lower limit value of luminances of the light sources, based on the histogram generated by the histogram generating unit.

14. An image display method for an image display device that has a display panel including a plurality of display elements; and a backlight including a plurality of light sources, the image display method comprising:
a signal processing step of obtaining display data and backlight control data, based on an input image;
a luminance range determining step of determining an upper limit value and a lower limit value of luminances of the light sources;
a panel driving step of outputting a signal for controlling light transmittances of the display elements to the display panel, based on the display data; and
a backlight driving step of outputting a signal for controlling the luminances of the light sources to the backlight, based on the backlight control data, wherein
in the signal processing step, when the backlight control data is obtained, the input image is divided into a plurality of areas and a luminance of light sources corresponding to each area is obtained within a range between the upper limit value and the lower limit value which are determined in the luminance range determining step.

15. The image display method according to claim 14, further comprising an average luminance calculating step of calculating an average luminance of the input image for one screen, wherein
in the luminance range determining step, an upper limit value and a lower limit value of luminances of the light sources are determined based on the calculated average luminance which is the average luminance calculated in the average luminance calculating step.

16. The image display method according to claim 15, wherein in the luminance range determining step, a lower limit value of luminances of the light sources is determined such that as the calculated average luminance increases the lower limit value increases.

17. The image display method according to claim 15, wherein in the luminance range determining step, an upper limit value of luminances of the light sources is determined such that as the calculated average luminance increases the upper limit value decreases.

18. The image display method according to claim 14, further comprising an illuminance detecting step of detecting an illuminance received by the display panel, wherein
in the luminance range determining step, an upper limit value and a lower limit value of luminances of the light sources are determined based on the detected illuminance which is the illuminance detected in the illuminance detecting step.

19. The image display method according to claim 18, wherein in the luminance range determining step, a lower limit value of luminances of the light sources is determined such that as the detected illuminance increases the lower limit value increases.

20. The image display method according to claim 18, wherein in the luminance range determining step, an upper limit value of luminances of the light sources is determined such that as the detected illuminance decreases the upper limit value decreases.

21. The image display method according to claim 18, wherein in the luminance range determining step, when the detected illuminance is lower than or equal to a predetermined illuminance, an upper limit value of luminances of the light sources is determined such that as the detected illuminance decreases the upper limit value decreases, and a lower limit value of luminances of the light sources is determined such that as the detected illuminance increases the lower limit value increases.

22. The image display method according to claim 14, further comprising a temperature detecting step of detecting a temperature of the backlight, wherein
in the luminance range determining step, an upper limit value and a lower limit value of luminances of the light sources are determined based on the detected temperature which is the temperature detected in the temperature detecting step.

23. The image display method according to claim 22, wherein in the luminance range determining step, when the detected temperature is higher than or equal to a predetermined temperature, an upper limit value of luminances of the light sources is determined such that as the detected temperature increases the upper limit value decreases.

24. The image display method according to claim 14, further comprising a moving image ratio calculating step of determining for each area whether an image in the area is a moving image or a still image and calculating, as a screen moving image ratio, a ratio of a number of areas that are determined to have moving images to a number of the plurality of areas, based on the input image, wherein
in the luminance range determining step, an upper limit value and a lower limit value of luminances of the light sources are determined based on the calculated screen moving image ratio which is the screen moving image ratio calculated in the moving image ratio calculating step.

25. The image display method according to claim 24, wherein in the luminance range determining step, when the calculated screen moving image ratio is lower than or equal to a predetermined value, a lower limit value of luminances of the light sources is determined such that as the calculated screen moving image ratio increases the lower limit value increases; and when the calculated screen moving image ratio is higher than or equal to the predetermined value, an upper limit value of luminances of the light sources is determined such that as the calculated screen moving image ratio increases the upper limit value decreases.

26. The image display method according to claim 14, further comprising a histogram generating step of generating a histogram representing a luminance distribution of the input image, wherein
in the luminance range determining step, an upper limit value and a lower limit value of luminances of the light sources are determined based on the histogram generated in the histogram generating step.
